(19) United States
(12) Patent Application Publication
(10) Pub. No.: US 2024/0380162 A1
(43) Pub. Date: Nov. 14, 2024

(54) RELIABLE CONNECTOR CONFIGURED FOR EASY LOCKING/UNLOCKING

(71) Applicant: Amphenol East Asia Limited (Hong Kong), Tsimshatsui (HK)

(72) Inventors: Mei-Chien Wu, Taoyuan City (TW); Lo-Wen Lu, Taoyuan City (TW); Wen-Te Hsu, Taoyuan City (TW)

(73) Assignee: Amphenol East Asia Limited (Hong Kong), Tsimshatsui (HK)

(21) Appl. No.: 18/659,552

(22) Filed: May 9, 2024

(30) Foreign Application Priority Data
May 10, 2023 (TW) 11220606
May 10, 2023 (TW) 112204604
May 10, 2023 (TW) 112204605

(51) Int. Cl. H01R 13/631; H01R 12/71; H01R 13/436

(52) U.S. Cl. CPC H01R 13/6315; H01R 12/716; H01R 13/436

(57) ABSTRACT

Reliable connectors configured for easy locking/unlocking. A connector can include a first end configured to mate with a first mating component in a first direction, and a second end configured to mate with a second mating component in a second direction perpendicular to the first direction. The connector can include a locking member configured to move between locked and unlocked positions by a force applied in a third direction perpendicular to both the first and second directions. Such a configuration reduces the risk of interfering with connections between the mated components when applying the force and therefore provide more reliable connectors. The connectors can include a shell with a guiding structure to reduce the risk of damage to lightweight connectors that might otherwise be damaged due to misalignment during mating/unmating. Such a shell can be used with locking members configured for using within electronic systems with densely packed components.

### CROSS REFERENCE TO RELATED APPLICATIONS

This application claims priority to and the benefit of Taiwan Patent Application Serial No. 112204604, filed on May 10, 2023. This application also claims priority to and the benefit of Taiwan Patent Application Serial No. 112204605, filed on May 10, 2023. This application claims priority to and the benefit of Taiwan Patent Application Serial No. 112204606, filed on May 10, 2023. The contents of these applications are incorporated herein by reference in their entirety.

### TECHNICAL FIELD

This application relates generally to interconnection systems, such as those including electrical connectors, used to interconnect electronic assemblies.

### BACKGROUND

With the development of communication technology and electronic technology, electronic devices with various functions, such as portable power source devices that can be carried for continuous power supply for a mobile phone, mobile phones that allow people to communicate on two sides of the world, portable audio players that allow people to listen to music everywhere at any time, personal computers that can assist people in handling various things, etc., have become indispensable tools in modern people's life and work.

In addition, for various electronic devices (e.g., smart phones, tablet computers, desktop computers, notebook computers, or digital cameras), in order to receive electronic signals and power from the outside, it is usually necessary to provide a signal connector on a housing of each electronic device. In general, signal connectors refer to all connecting assemblies and their accessories applied to electronic signals and power and are bridges for all signals, and the quality thereof affects the reliability of current and signal transmission and is also closely related to the operation of electronic devices. In addition, by a signal connector, a plurality of electronic devices can be connected to form a complete system so as to transmit electronic signals or power to each other, and thus it can be seen that the signal connector is an essential element for each electronic device to realize predetermined functions.

### SUMMARY

Aspects of the present disclosure relate to reliable connector configured for easy locking/unlocking.

Some embodiments relate to an electrical connector. The electrical connector may comprise a housing comprising a first mating end extending in a first direction, and a second mating end extending toward a second direction perpendicular to the first direction; and a locking member connected to a sidewall of the housing and configured to move between a locked position and an unlocked position by a force in a third direction perpendicular to both the first direction and the second direction.

Optionally, the electrical connector comprises a circuit board held in the housing and comprising an end extending out of the second mating end of the housing, wherein the first mating end of the housing comprises a slot; and the end of the circuit board comprising a plurality of contact pads.

Optionally, the housing comprises a third end opposite to the first end in the first direction; the electrical connector further comprises a plurality of cables extending out of the housing from the third end; and the plurality of cables are electrically connected to the circuit board.

Optionally, the locking member comprises an activation portion and a latching portion disposed opposite to the activation portion in the second direction; the activation portion of the locking member is disposed above the housing; and the latching portion is configured to move away from or towards the sidewall of the housing by the force in the third direction on the activation portion.

Optionally, the housing comprises a block protruding from the sidewall; and the locking member is pivotably connected to the block.

Optionally, the electrical connector further comprises an elastic element disposed between the housing and the locking member and configured to apply the force in the third direction to the locking member which moves the latching portion toward the sidewall of the housing.

Optionally, the elastic element comprises a first end accommodated in a slot of the housing, and a second end abutting an inner wall of the activation portion of the locking member.

Optionally, the housing comprises a first subassembly comprising the first mating end, and a second subassembly connected to the first subassembly and comprising the second mating end and the third end; the circuit board is held in the second subassembly; and the locking member is connected to a sidewall of the second subassembly.

Optionally, the first subassembly comprises a first insulative housing comprises a slot at the first mating end; and a plurality of terminals held in the first insulative housing, each of the plurality of terminals comprising a first end curving into the slot at the first mating end and a second end extending out of the first insulative housing and electrically connected to the circuit board held in the second subassembly.

Some embodiments relate to a shell for an electrical connector. The shell may comprise a first long side wall; a second long side wall opposing the first long side wall; and front and rear short side wall opposing each other and joining the first and second long side walls, respectively, so as to form an enclosure with the first and second long side walls, wherein the front short side wall comprises a first groove recessed from a top; and the rear short side wall comprises a second groove recessed from the top.

Optionally, the second groove of the rear short side wall is narrower than the first groove of the front short side wall.

Optionally, the first groove extends closer to a bottom than the second groove.

Optionally, the first groove and the second groove have a same height in a top-to-bottom direction.

Optionally, the shell comprises at least one tab protruding from the top, each of the at least one tab bent away from the enclosure.

Optionally, the first long side wall comprises two tabs protruding from the top; and the first long side wall is taller between the two tabs than outside the two tabs in a top-to-bottom direction and comprises at least a portion of a locking member.

Optionally, the first groove is narrower than the first short side wall so as to form at least one first guide wall; and the second groove is narrower than the second short side wall so as to form at least one second guide wall.

Optionally, the shell comprises at least one positioning portion having an clastic sheet and a hole extending therethrough.

Some embodiments relate to an electrical connector. The electrical connector may comprise a shell described herein; an insulative housing disposed in the shell and comprising a slot accessible from the top of the shell; and at least one terminal group held in the insulative housing and comprising a plurality of terminals, each of the plurality of terminals comprising a first end curving into the slot of the insulative housing and a second end opposite the first end and extending out of the shell.

Optionally, the insulative housing is disposed below both the first groove of the front short side wall and the second groove of the rear short side wall.

Optionally, the insulative housing comprises at least one positioning portion configured to mate with the at least one positioning portion of the shell.

Optionally, the insulative housing comprises at least one bearing portion protruding outwardly so as to abut a bottom edge of the shell.

Some embodiments relate to a connector assembly. The connector assembly may comprise a plug connector comprising front and rear ends opposite to each other and both substantially extending along a first axis, and a vertical end extending substantially along a second axis perpendicular to the first axis; a socket connector comprising a vertical end extending along the second axis and configured to with the vertical end of the plug connector; a first locking member movably disposed on the plug connector or socket connector; and extending substantially along the second axis, wherein the first locking member may be operated to form a locked or unlocked state with the second locking member; and a second locking member disposed on the socket connector or the plug connector and configured to mate with the first locking member so as to restrain movement between the plug connector and the socket connector along both the first axis and the second axis.

Optionally, the socket connector comprises a shell comprising a first long side wall; a second long side wall opposing the first long side wall; a front short side wall joining the first and second long side walls and a first groove recessed from a top and configured to receive the front end of the plug connector; and a rear short side wall opposing the front short side wall and joining the first and second long side walls and comprising a second groove recessed from the top and configured to receive the rear end of the plug connector.

Optionally, the socket connector comprises an insulative housing disposed in the shell and below both the first groove and the second groove such that the shell holds a portion of the plug connector when the plug connector is mated with the socket connector.

Optionally, the first groove is wider than the second groove.

Optionally, the shell of the socket connector comprises the second locking member disposed adjacent the top of the shell and configured to receive a latching portion of the first locking member disposed on the plug connector.

These techniques may be used alone or in any suitable combination. The foregoing is a non-limiting summary of the application, which is defined by the attached claims.

### BRIEF DESCRIPTION OF DRAWINGS

The accompanying drawings may not be intended to be drawn to scale. In the drawings, each identical or nearly identical component that is illustrated in various figures may be represented by a like numeral. For purposes of clarity, not every component may be labeled in every drawing. In the drawings:

FIG. 1 is an exploded view of a connector assembly, the connector assembly comprising a plug connector and a socket connector, according to a first embodiment.

FIG. 2A is a front perspective view of the connector assembly of FIG. 1, illustrating a locked state between a first locking member and a second locking member, according to the first embodiment.

FIG. 2B is a front perspective view of the connector assembly of FIG. 1, illustrating an unlocked state between the first locking member and the second locking member, according to the first embodiment.

FIG. 3 is a rear perspective view of the connector assembly of FIG. 1, according to the first embodiment.

FIG. 4 is an elevation view of the plug connector of the connector assembly of FIG. 1, according to the first embodiment.

FIG. 5 is an exploded view of the plug connector of FIG. 4, according to the first embodiment.

FIG. 6 is a front view of the plug connector of FIG. 4, schematically illustrating pivoting of a locking member, according to the first embodiment.

FIG. 7 is an exploded view of the socket connector of the connector assembly of FIG. 1, according to the first embodiment.

FIG. 8 is a front perspective view of the socket connector of FIG. 7, according to the first embodiment.

FIG. 9 is a rear perspective view of the socket connector of FIG. 7, according to the first embodiment.

FIG. 10 is a top view of the socket connector of FIG. 7, according to the first embodiment.

FIGS. 11A and 11B are cross-sectional views of the socket connector of FIG. 7, sectioned along a line marked “11A/B-11A/B” in FIG. 10, according to the first embodiment.

FIG. 12 is an exploded view of a connector assembly, according to a second embodiment.

FIG. 13 is a perspective view of the connector assembly of FIG. 12, illustrating an unlocked state between a first locking member and a second locking member, according to the second embodiment.

FIG. 14 is a perspective view of the connector assembly of FIG. 12, a locked state between a first locking member and a second locking member, according to the second embodiment.

### DETAILED DESCRIPTION

The inventors have recognized and appreciated designs for a reliable connector that can avoid problems, such as unstable signal transmission, increased current loss, impaired electrical performance, increased risk of device damage, increased maintenance cost, and impaired user experience, so some manufacturers have designed locking structures to improve the stability of connector connection. Such connectors may include a compact locking members configured for easy locking/unlocking even in an environment full of other components and wires. In contrast, a user performing the unlocking process with a known design may be susceptible to interference from other components and wires, which reduces the unlocking efficiency. In addition, when moving or repositioning another component or wire, a user of a conventional design may be more likely to accidentally contact the locking structure, leading to inadequate locking.

Such connectors may alternatively or additionally include designs for lightweight connectors that have good insertion and pullout performance and assembly stability in use, and that are resistant to damage if misaligned during mating. The inventors have recognized and appreciated that it often may be desirable to make connectors that are lighter and thinner to meet requirements for increasingly lightened and thinned electronic products and to avoid occupying too much space. However, during manual insertion and pullout of such connectors, internal elements (such as a tongue plate or a terminal) are likely to be broken and damaged due to problems such as deviation of an insertion direction and improper application of force, which affects the operation of the connector.

The inventors have further recognized and appreciated that conventional aligning structures, or the internal connector components (such as a tongue plate or a terminal) of the connector, are likely to be damaged due to problems such as a deviated connection direction and inappropriate application of force, which affects the operation of the connector. These issues may be particularly problematic as connectors become more lightweight. Alternatively or additionally, connectors as described herein may be easy to connect and disconnect during use and may be assembled securely, while being easily releasable by a user.

One objective of the present disclosure is to provide a shell with a guide structure, which can be applied to a socket connector. The shell comprises a first short side wall, a second short side wall, a first long side wall, and a second long side wall, wherein the first short side wall is provided with a first groove; the second short side wall is opposite the first short side wall and is provided with a second groove; two sides of the first long side wall are respectively connected to the first short side wall and the second short side wall; and the second long side wall is opposite the first long side wall, and two sides of the second long side wall are respectively connected to the first short side wall and the second short side wall, so that the first short side wall, the second short side wall, the first long side wall and the second long side wall can be enclosed to form a slot. In this way, with the arrangement of the first groove and the second groove, during the insertion of a plug connector into the socket connector provided with the shell, the plug connector can be inserted into the socket connector smoothly and correctly under limiting and guiding effects of inner wall faces of the first groove and the second groove.

Another objective of the present disclosure is to provide a socket connector with a guide structure, comprising a shell described above, an insulative housing, and at least one terminal group, wherein the insulative housing can be accommodated in a slot of the shell, at least one slot is provided in the insulative housing with one end provided with at least one mating interface, and each mating interface can be in communication with a corresponding slot; each terminal group can be arranged in the insulative housing and comprises a plurality of terminals, wherein one end of each of the terminals can be exposed out of the slot; since a first groove of the first short side wall can be configured to match one end of a plug connector, one end of the plug connector can be guided and accommodated; and a second groove of the second short side wall can be configured to match the other end of the plug connector, so that the other end of the plug connector can be guided and accommodated. In this way, with the arrangement of the first groove and the second groove, during insertion into the socket connector, the plug connector can be inserted into the socket connector smoothly and correctly under limiting and guiding effects of inner wall faces of the first groove and the second groove.

An objective of the present disclosure is to provide a connector assembly with a transverse locking configuration, comprising a plug connector, a socket connector, a first locking member, and a second locking member, wherein the plug connector may be provided with a first longitudinal end, a second longitudinal end, and a vertical end, wherein the first longitudinal end and the second longitudinal end are arranged opposite to each other and substantially extend respectively along a longitudinal axis (e.g., X-axis) direction, and the vertical end substantially extends along a vertical axis (e.g., Z-axis) direction; one end of the socket connector is provided with a vertical end, which extends along the vertical axis direction and can be electrically connected to the vertical end; the second locking member may be arranged on the socket connector or the plug connector, substantially along a transverse axis (e.g., Y-axis) direction, and the transverse axis (e.g., Y-axis), the longitudinal axis (e.g., X-axis), and the vertical end (e.g., extending along Z-axis) are orthogonal to one another; the first locking member may be flexibly arranged on the plug connector or socket connector, being substantially arranged along the transverse axis (e.g., Y-axis) direction, and the first locking member is operable when receiving a force to form a locking or unlocked state with the second locking member. Thus, since the second locking member and the first locking member are both arranged along the transverse axis (e.g., Y-axis), they are kept away from other axial structures and components, and, during the process of locking and unlocking by a user, the user's hand moves substantially along the transverse axis (e.g., Y-axis), which can better reduce interference from other axial structures and components, thus greatly improving the convenience of use.

An objective of the present disclosure is to provide a plug connector with an easy unlocking configuration, comprising a housing and a first locking member, wherein the housing is provided with a first longitudinal end, a second longitudinal end, and a vertical end, wherein the first longitudinal end and the second longitudinal end are arranged opposite to each other, and the first axes of the extension directions thereof are respectively orthogonal to the second axis of the extension direction of the vertical end; the first locking member may be pivoted to one sidewall of the housing, with one end provided with an activation portion and the other end provided with at least one latching portion, the extension direction of the activation portion faces away from the vertical end, and the activation portion can be higher than the housing in the direction of the second axis, and, when the activation portion is displaced upon receiving a force, it causes each latching portion to move away from or toward said sidewall of the housing; when the plug connector is connected to a socket connector, the vertical end can be electrically connected to the socket connector, and each latching portion can be interlocked with the second locking member of the socket connector to form a locked state, and, when the activation portion is pressed and displaced, each latching portion can be detached from the second locking member of the socket connector to form an unlocked state, such that to initiate an unlocking action, a user simply presses the activation portion with a finger to quickly unlock the plug connector and the socket connector to easily disconnect the plug connector, so it greatly improves the convenience of disassembly.

To make clearer the objectives, technical content, and advantages of the present application, the present application will be described in greater detail below in conjunction with specific embodiments by referring to the drawings. Those of ordinary skill in the art can understand the advantages and effects of the present application through the content disclosed herein, and the present application may be implemented or applied through other specific embodiments; details of the description may be modified and changed based on different perspectives and applications without departing from the spirit of the present application. In addition, it is stated beforehand that the drawings in the present application are only for purposes of schematic illustration, rather than being depictions according to actual dimensions. Moreover, unless explicitly stated or defined otherwise in the context, the meanings of “one” and “said” in the present application include the plural. Further, in the following embodiments, relevant technical content of the present application will be described in greater detail, but the disclosed content is not intended to limit the scope of protection of the present application.

It should be understood that the terms herein usually have common meanings in the field, and where a conflict arises, any definition given herein shall prevail. Since the same thing may be expressed in a number of ways, substitute words and synonyms may be used for any term discussed or described herein, and there are no special restrictions on whether to elaborate on or discuss terms herein, wherein the use of one or more synonyms should not exclude other synonyms. The embodiments used anywhere in the description of the present application, including the use of any terms, are only illustrative, rather than limiting the scope or meaning of the present application or any terms. Similarly, the present application is not limited to the various embodiments disclosed in the description. Although terms like “first”, “second”, and “third” may be used herein to describe various components, each component should not be limited by any of the aforementioned terms, wherein the aforementioned terms are mainly intended to distinguish one component from another, rather than imposing any substantive restrictions on any component or on the assembly or arrangement sequence of each component in practical applications. In addition, the directional terms mentioned in the embodiments, such as “upper”, “lower”, “front”, “rear”, “left”, and “right”, are only directions indicated by referring to the drawings. Therefore, the directional terms used are intended to explain, rather than limit, the scope of protection of the present application. In addition, the term “or” as used herein should include any or more combinations of related listed items depending on the actual situation.

Further, the terms “substantially” or “approximately” as used herein can refer to the values within a range of deviations from a specific value or the average of a plurality of values that may be recognized or determined by those of ordinary skill in the art, including certain specific errors that, due to limitations of the measurement system or equipment, may occur when the specific value is measured, and, for example, a value referred to by using the term “substantially” can include ±5%, ±3%, ±1%, ±0.5%, or ±0.1% of the specific value and one or more standard deviation ranges.

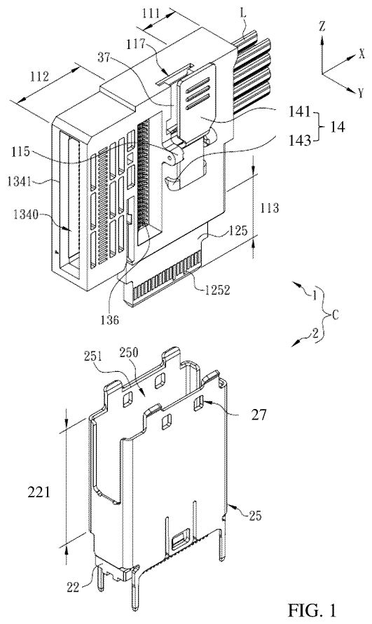

The present application relates to a connector assembly with a transverse locking configuration, and it is hereby specially stated that the spatial shape of a component in the present application is defined by three mutually orthogonal axes, namely the longitudinal axis (X-axis), the transverse axis (Y-axis), and the vertical axis (Z-axis), as shown in FIG. 1, with the longitudinal axis direction as the front-rear direction of the component, the transverse axis direction as the left-right direction of the component, and the vertical axis direction as the upper (top)-lower (bottom) direction of the component.

FIG. 1 is an exploded view of a connector assembly according to a first embodiment. Referring to FIG. 1, the connector assembly C comprises a plug connector 1 and a socket connector 2. The plug connector 1 comprises a first locking member 14. The socket connector 2 comprises a second locking member 27. The plug connector 1 includes a first longitudinal end 111, a second longitudinal end 112, and a vertical end 113. The first longitudinal end 111 and the second longitudinal end 112 may face each other and may extend and be arranged along the longitudinal axis (X-axis) direction respectively. As shown in FIG. 1, the first longitudinal end 111 may be located in a rear-end area of the plug connector 1, which can be electrically connected to at least one cable L, and the first longitudinal end 111 is substantially connected to the cable L along the longitudinal axis (X-axis) direction.

Again, referring to FIG. 1, the second longitudinal end 112 may be located in a front-end area of the plug connector 1 and can be electrically connected to another connector. As shown in FIG. 1, the second longitudinal end 112 is configured to connect to another connector along the longitudinal axis (X-axis) direction. Further, the vertical end 113 is located in a bottom-end area of the plug connector 1 and may substantially extend downward along the vertical axis (Z-axis), so the extension axis of the first longitudinal end 111 and the second longitudinal end 112 will be substantially orthogonal to the extension axis of the vertical end 113.

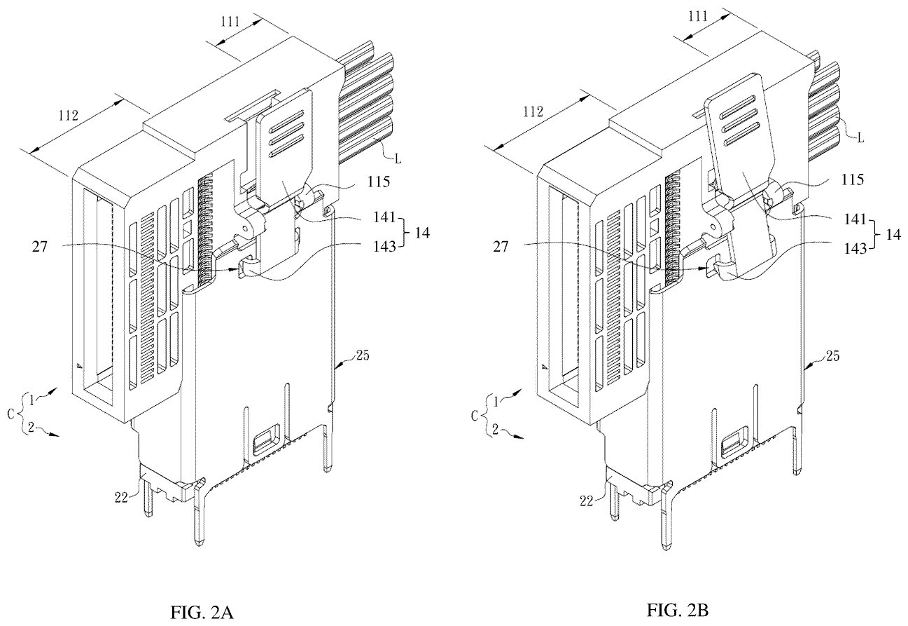

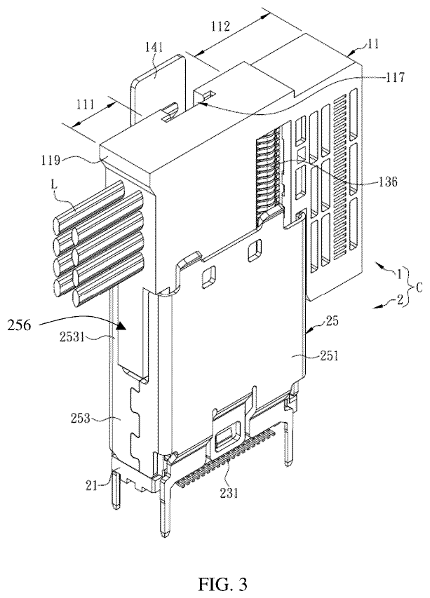

In addition, again referring to FIG. 1, one end (for example, the top) of the socket connector 2 is provided with a vertical end 221. The vertical end 221 may extend upward along the vertical axis (Z-axis), and, when the socket connector 2 and the plug connector 1 are connected to each other, the vertical end 221 can be electrically connected by the vertical end 113 by plugging from top down. Further, the first locking member 14 is movably arranged on the plug connector 1, substantially arranged along the vertical axis (Z-axis) direction. As shown in FIG. 1, the first locking member 14 is located on the right side of the plug connector 1. In addition, the second locking member 27 is arranged on the socket connector 2. As shown in FIG. 1, the second locking member 27 is located on the right side of the socket connector 2. As can be seen in FIGS. 1-2B, the second locking member 27 is positioned to block movement of the first locking member 14 in a direction for withdrawing the plug connector 1 from the socket connector 2.

FIG. 2A is a perspective view of the connector assembly C, illustrating a locked state between a first locking member and a second locking member according to the first embodiment. FIG. 2B is a perspective view of the connector assembly C, illustrating an unlocked state between a first locking member and a second locking member according to the first embodiment. Further, as shown in FIG. 1, FIG. 2A and FIG. 2B, the first locking member 14 is operable by a user to form a locked state (as shown in FIG. 2A) or an unlocked state (as shown in FIG. 2B) with the second locking member 27. The first locking member 14 and the second locking member 27 are arranged substantially along the transverse axis (Y-axis) direction of the plug connector 1 and the socket connector 2, so that locking/unlocking actions thereof or operations by a user's hand are performed substantially in the transverse axis (Y-axis) direction, and, for example, the lower half of the first locking member 14 is movable from right to left to lock to the second locking member 27, or the lower half of the first locking member 14 is movable from left to right to detach from the second locking member 27, while operations by the user's hand are also performed substantially in the transverse axis (Y-axis) direction, and, for example, the user's hand can exert pressure on the upper half of the first locking member 14 from right to left. Therefore, meeting the aforementioned conditions is considered the arrangement of the first locking member 14/second locking member 27 along the transverse axis (Y-axis) direction in the present application.

Since the plug connector 1 is provided with ends (such as the first longitudinal end 111, the second longitudinal end 112, and the vertical end 113) for connecting to other apparatuses (such as the socket connector 2, the cable L, or another connector) in the longitudinal axis (X-axis) and vertical axis (Z-axis) directions thereof, respectively, while the locking members (such as the first locking member 14 and the second locking member 27) used to secure the plug connector 1 and the socket connector 2 are arranged along the transverse axis (Y-axis) direction, when a user operates the first locking member 14 and/or second locking member 27, his/her hand usually operates and moves along the transverse axis (Y-axis) direction, without being affected by any other apparatus in the longitudinal axis (X-axis) and vertical axis (Z-axis) directions, which greatly improves the convenience of locking/unlocking operations. In addition, since the first longitudinal end 111 and the second longitudinal end 112 are arranged along the longitudinal axis (X-axis) direction, when another apparatus (for example, the cable L or another connector) is plugged or unplugged, the direction of the force, or the action thereof is usually along the longitudinal axis (X-axis) direction, which makes it unlikely to affect the first locking member 14 or the second locking member 27, so that the first locking member 14 and the second locking member 27 remain in a secure locked state.

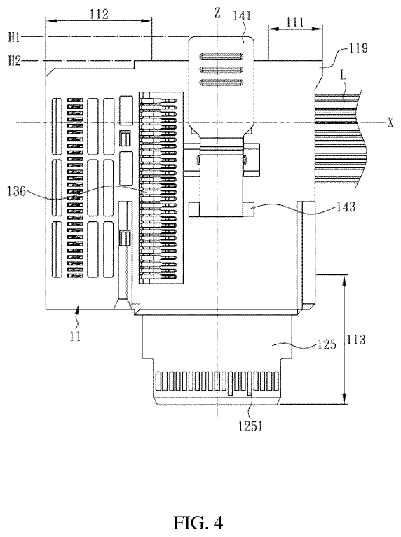

FIG. 3 is a rear perspective view of the connector assembly C, according to the first embodiment. As shown in FIG. 3, when the vertical end 113 of the plug connector 1 extends into the slot 250 of the socket connector 2 and is electrically connected to the terminal group 23, the first longitudinal end 111 of the plug connector 1 can be accommodated in the first groove 256 of the socket connector 2.

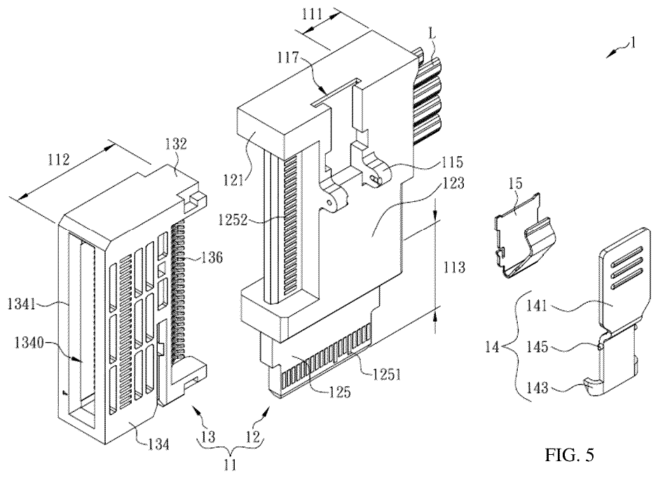

FIG. 4 is a cross-sectional view of the plug connector according to the first embodiment. As shown in FIG. 4, the plug connector 1 comprises a housing 11 and a first locking member 14, the housing 11 is provided with a first longitudinal end 111, a second longitudinal end 112, and a vertical end 113. In this embodiment, the first longitudinal end 111 is located in the rear-end direction of the housing 11, and the second longitudinal end 112 is located in the front-end direction of the housing 11, so that the first longitudinal end 111 and the second longitudinal end 112 face each other, and the vertical end 113 is located in the bottom-end direction of the housing 11, so that the first axis X (the front-rear direction) in the extension direction of the first longitudinal end 111 and that of the second longitudinal end 112 will be substantially orthogonal to the second axis Z (the up-down direction) in the extension direction of the vertical end 113, respectively. Further, again referring to FIG. 3 and FIG. 4, and in this embodiment, the housing 11 corresponds to the position of the first longitudinal end 111, at least one grip portion 119 is protrusively arranged along the extension direction of the first axis X of the first longitudinal end 111, and to disconnect the plug connector 1, a user may grip the front and rear ends of the housing 11 with the thumb and middle finger respectively, and press the activation portion 141 with the index finger, thereby completing the unlocking operation, and further, during the aforementioned operation, the user's thumb may be pressed against the bottom area of the grip portion 119, in which case, when the user pulls the plug connector 1 upward, the thumb may be resisted by the grip portion 119 when applying an upward force, which helps the user apply a force to the housing 11 and prevents failure in disconnecting the plug connector 1 due to a slip of the hand. However, in another embodiment of the present application, the grip portion 119 may also be located in a position corresponding to the second longitudinal end 112, rather than being limited to being located only at the first longitudinal end 111, thereby improving the resilience of design of the plug connector 1.

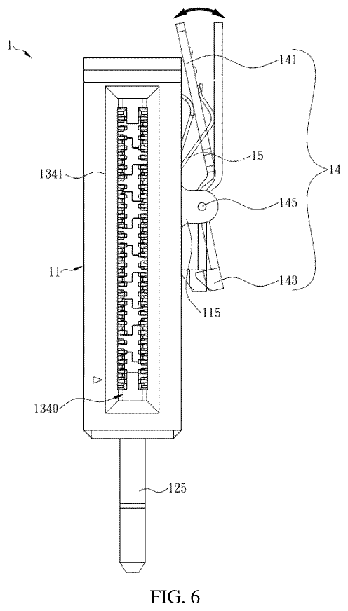

FIG. 5 is an exploded view of the plug connector according to the first embodiment. Again referring to FIG. 1, FIG. 4 and FIG. 5, and in this embodiment, the housing 11 includes a first subassembly 12 and a second subassembly 13. The first subassembly 12 comprises the first longitudinal end 111 and the vertical end 113, and the first mating portion 121 and the first longitudinal end 111 may face each other and may be respectively arranged to extend along the longitudinal axis (X-axis) direction, one end (for example, the front end) of which is provided with a first mating portion 121, another end (for example, the rear end) of which opposite to the first mating portion 121 is provided with the first longitudinal end 111, and yet another end (for example, the bottom end) of which is provided with the vertical end 113. The second subassembly 13 comprises the second longitudinal end 112, one end (for example, the front end) of which is provided with the second longitudinal end 112, and the other end (for example, the rear end) of which opposite to the second longitudinal end 112 is provided with a second mating portion 132, and the second mating portion 132 can be mated with the first mating portion 121. In this embodiment, the first mating portion 121 and the second mating portion 132 are integrated by thermal bonding technology (for example, high frequency welding), so that the plastic portion of the finally formed housing 11 is like a single component, but not limited thereto. According to product and process requirements, the first mating portion 121 and the second mating portion 132 may also be mated by embedding, tight fit, clamping, bonding or by another technology, or, in some embodiments, the housing 11 may be designed as a single component or composed of three or more components, rather than being limited to the two components of the first subassembly 12 and the second subassembly 13 mentioned above.

Again, referring to FIG. 1, FIG. 4 and FIG. 5, and in the first embodiment, the first subassembly 12 comprises a first insulative housing 123 and a circuit board 125, and the circuit board 125 may be fixed to the interior of the first insulative housing 123 using insulative material packaging technology, the insulative materials including various resins, plastics, or other insulative materials. One end (for example, the front end) of the first insulative housing 123 is provided with the first mating portion 121, the first mating portion 121 having an inwardly curved configuration (but not limited thereto), so that one side (for example, the front side) of the circuit board 125 may be exposed, and the exposed circuit board 125 may be further provided with a plurality of first conductive blades (also known as Gold Fingers) 1252; further, the cable L may be electrically connected to the circuit board 125 and may be fixed to another end (for example, the rear end) of the first insulative housing 123 using insulative material packaging technology. The area at another end of the first insulative housing 123 where the cable L is located is the first longitudinal end 111; further, one end (for example, the bottom end) of the circuit board 125 can be exposed outside yet another end (for example, the bottom end) of the first insulative housing 123, on which a plurality of straight conductive blades 1251 are arranged. One end of the circuit board 125 and said another end of the first insulative housing 123 can jointly form the vertical end 113. However, in another embodiment of the present application, with the plug connector 1, it is possible to, according to needs, adjust the structures of the components (such as the first conductive blade 1252, the straight conductive blade 1251, and the cable L) corresponding to the first longitudinal end 111, the vertical end 113, and the first mating portion 121 for transmitting electrical signals.

Again, referring to FIG. 4 and FIG. 5, and in this embodiment, the second subassembly 13 comprises a second insulative housing 134 and a plurality of terminals 136. One end (for example, the front end) of the second insulative housing 134 and one end of the terminal 136 can jointly form the second longitudinal end 112, another end (for example, the rear end) of the second insulative housing 134 is provided with the second mating portion 132, the second bonding portion 132 having an inwardly curved configuration (but not limited thereto), and the second insulative housing 134 is further provided with a mating interface 1341 corresponding to the position of the second longitudinal end 112, which is provided with a slot 1340 on the inside, and the mating interface 1341 can be connected to the slot 1340. Each terminal 136 may be a power terminal, signal terminal, or grounding terminal according to its designated function, and the terminals 136 included in the second subassembly 13 may all be terminals with the same function (for example, all are power terminals), or terminals with different functions (for example, signal terminals and grounding terminals) are arranged together. Further, each terminal 136 may be fixed to the second insulative housing 134, one end (for example, the front end) of which may be exposed outside the slot 1340 and the other end of which may be exposed outside the second mating portion 132; thus, when another connector is connected to the second subassembly 13, a component (for example, a metal terminal) used by said another connector to transmit electrical signals may extend into the slot 1340 through the mating interface 1341 and be electrically connected to each terminal 136; further, when the second subassembly 13 is mated with the first subassembly 12, the second mating portion 132 and the first mating portion 121 may be integrated (by hot bonding technology, for example), and the other ends of each terminal 136 may be electrically connected to the corresponding first conductive blade 1252, respectively. However, in another embodiment of the present application, the second subassembly 13 may be provided with only a second insulative housing 134, without the terminal 136, and a component used by another connector to transmit electrical signals can be directly and electrically connected to the first subassembly 12. For example, a metal terminal of another connector may be directly and electrically connected to the first conductive blade 1252; alternatively, the second subassembly 13 may further be provided with another component for transmitting electrical signals, rather than being limited to the component form of the terminal in FIG. 5.

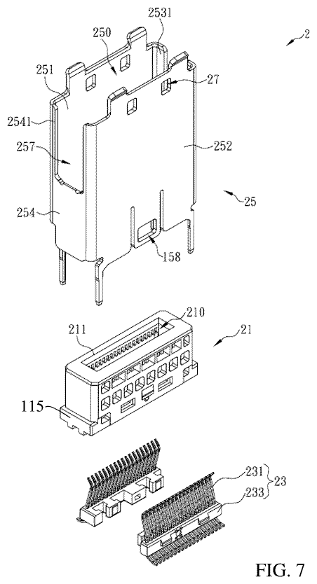

FIG. 6 is a front view of the plug connector according to the first embodiment. In addition, as shown in FIG. 1, FIG. 4, FIG. 5 and FIG. 6, the first locking member 14 is pivotably connected to one sidewall (for example, the right sidewall) of the housing 11, with one end provided with an activation portion 141 and the other end provided with a latching portion 143. The activation portion 141 extends upward along the direction of a second axis Z, which enables that the extension direction of the activation portion 141 faces away from the extension direction of the vertical end 113 (extending downward). Further, the activation portion 141 may be substantially higher than the housing 11 in the direction of the second axis Z. For example, the horizontal height H1 of the top surface of the activation portion 141 can, in its position on the second axis Z, exceed the horizontal height H2 of the top surface of the housing 11.

Again, referring to FIG. 1, FIG. 4, FIG. 5 and FIG. 6, when a user presses the activation portion 141 with a finger, the activation portion 141 is displaced by the force and can move the latching portion 143 away from or toward the sidewall of the housing 11. Since the activation portion 141 is relatively high, it has a larger space to move and can go beyond the upper side of the housing 11 (as shown in FIG. 4), which increases the distance between the latching portion 143 and the sidewall of the housing 11 to ensure the completion of an unlocking action to be described later, and, since the activation portion 141 is relatively high, when the user operates the activation portion 141 with fingers, the operations are unlikely to be hindered or blocked by adjacent components (such as the sidewall of the housing 11), which enables that the activation portion 141 provides a relatively large space for operations to enhance the convenience of an unlocking operation. In this embodiment, two pivot blocks 115 are protrusively arranged on the sidewall of the housing 11, the pivot blocks 115 being spaced at a distance from each other, and the first locking member 14 is protrusively provided with a pivot portion 145 on two opposite sides, respectively, each pivot portion 145 being pivotable to the corresponding pivot block 115 so that the first locking member 14 can rotate with the junction of each pivot portion 145 and the pivot block 115 as the center of axis of rotation. However, in another embodiment of the present application, another pivot structure may be used between the first locking member 14 and the housing 11, without being limited to the form shown in FIG. 3, as long as the first locking member 14 is rotatable on the housing 11 and causes the latching portion 143 to synchronously move away from or toward said sidewall of the housing 11.

Further, referring to FIG. 1, FIG. 4, FIG. 5 and FIG. 6, an elastic element 15 is further disposed between the first locking member 14 and the housing 11. The elastic element may be capable of applying a force to the first locking member 14. The forces may be capable of causing the latching portion 143 to move toward said sidewall of the housing 11. One end of the elastic element 15 may be fixed to an assembly slot 117 of the housing 11, and the other end of the elastic element 15 can rest against the inner sidewall of the activation portion 141 of the first locking member 14. It should be noted that the inside direction of the activation portion 141 refers to the direction in which it faces the housing 11, while the outside direction of the activation portion 141 refers to the direction in which it faces away from the housing 11. As mentioned earlier, the other end of the elastic element 15 will apply a force to the activation portion 141 (for example, the elastic element 15 represented by the imaginary lines shown in FIG. 6) to push the activation portion 141 away from the housing 11, and at the same time, the latching portion 143 will synchronously move toward the housing 11. Further, when a user applies a force to the outer sidewall of the activation portion 141 and overcomes the applied force of the elastic element 15, the activation portion 141 will move toward the housing 11, and at the same time, the latching portion 143 will synchronously move away from the housing 11 to separate from the housing 11 by a distance, and therefore, the further the activation portion 141 is displaced toward the housing 11, the greater the distance between the latching portion 143 and the housing 11 is, which guarantees completion of the unlocking. In this embodiment, the first locking member 14 and related pivot structure (for example, the pivot block 115) may be arranged on the first insulative housing 123, but the present application is not limited thereto, and according to the need of a product, the first locking member 14 and related pivot structure may also be arranged on the second insulative housing 134.

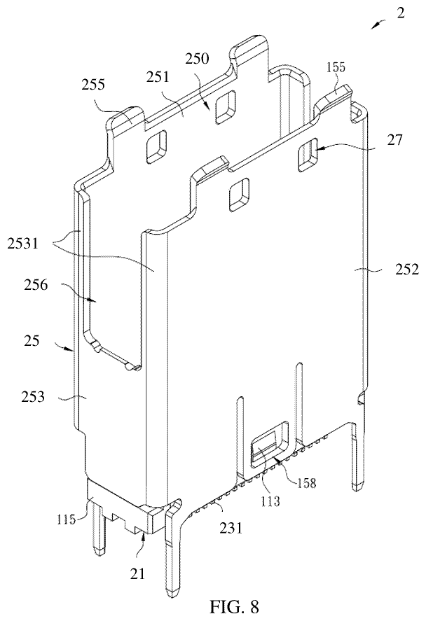

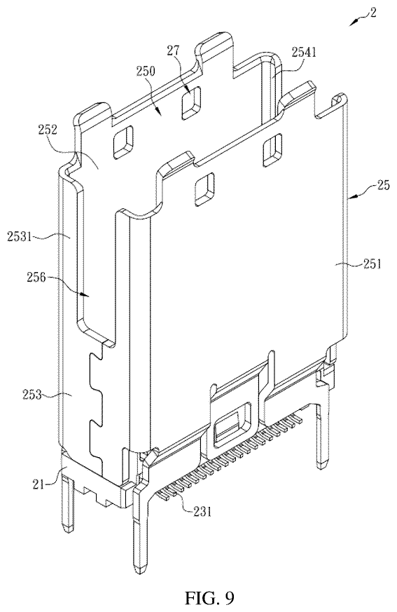

FIG. 7 is an exploded view of the socket connector according to the first embodiment. Referring to FIG. 1, FIG. 7 and FIG. 8, the socket connector 2 comprises an insulative housing 21, at least one terminal group 23, and a shell 25. The insulative housing 21 is internally provided with a slot 210 and is provided with a mating interface 211 at one end (for example, the top end) thereof, and the mating interface 211 can be connected to the slot 210. However, in another embodiment of the present application, according to the need of a product, the insulative housing 21 may be provided with a plurality of mating interfaces 211, and the mating interfaces 211 can be connected to the same slot 210; alternatively, the insulative housing 21 may be provided with a plurality of mating interfaces 211 and a plurality of slots 210, and each mating interface 211 can be connected to each slot 210.

Further, again referring to FIG. 1, FIG. 7 and FIG. 8, the terminal group 23 may be assembled into the insulative housing 21, which comprises at least a plurality of terminals 231, and, in this embodiment, the terminal 231 may also be fixed to a terminal housing 233 (but not limited thereto), each terminal 231 may be a power terminal, signal terminal, or grounding terminal according to its designated function, and the terminals 231 included in the same terminal group 23 may all be terminals with the same function (e.g., all power terminals), or terminals with different functions (e.g., both signal terminals and grounding terminals) are arranged together. Further, after the terminal group 23 is assembled onto the insulative housing 21, one end of the terminal 231 may be exposed outside the slot 210 so that it can be electrically connected to the straight conductive blade 1251 of the plug connector 1. The terminal housings 133 of the two terminal sets 13 can be combined with each other as a whole to be assembled into the insulative housing 21 more conveniently.

Further, as shown in FIG. 1, FIG. 7 and FIG. 8, the shell 25 comprises a first long side wall 251, a second long side wall 252, a first short side wall 253, and a second short side wall 254. The first long side wall 251 can serve as the left side wall of the shell 25, the two sides of which are respectively connected to the first short side wall 253 and the second short side wall 254, and the second long side wall 252 can serve as the right side wall of the shell 25, the two sides of which are respectively connected to the first short side wall 253 and the second short side wall 254, so that the first short side wall 253 can serve as the rear side wall of the shell 25, and the second short side wall 254 can serve as the front side wall of the shell 25, and the first long side wall 251, the second long side wall 252, the first short side wall 253, and the second short side wall 254 can jointly surround a slot 250. In this embodiment, the second long side wall 252 is provided with two second locking members 27 at one end (for example, the top end) adjacent to the shell 25, each second locking member 27 being a through hole, and the configuration of each through hole matches the configuration of the latching portion 143 of the first locking member 14, so that at least the tips of the latching portion 143 can extend into the corresponding through holes, respectively; however, the present application is not limited thereto, and, in another embodiment of the present application, the number and configuration of the second locking members 27 are changeable according to the first locking member 14, and for example, the number of second locking members 27 is only one or three or more. Further, in this embodiment, when the vertical end 113 of the plug connector 1 extends into the slot 250 and is electrically connected to the connector 2 (for example, the terminal 231 and the straight conductive blade 1251 abut against each other), the tips of the latching portion 143 can respectively extend into the corresponding through holes, so that the first locking member 14 engages the second locking member 27 to cause the connector 2 and the plug connector 1 form a stable locked state (as shown in FIG. 2A; then, to unlock it, the user can press the activation portion 141 with a finger, causing the tips of the latching portion 143 to respectively detach from the corresponding through holes, so that the connector 2 and the plug connector 1 form an unlocked state (as shown in FIG. 2B), so the user can easily unlock them simply by gripping two ends (for example, the front and rear ends) of the plug connector 1 and operating (pressing) the first locking member 14 with a finger to unlock the plug connector 1 from the connector 2, and at the same time, during the aforementioned pressing process, the finger may go above the top surface of the plug connector 1, unlikely to be hindered by any adjacent components, and the latching portion 143 may further be substantially away from the corresponding second locking member 27 due to a large amplitude of rotation of the activation portion 141, which greatly improves the convenience of use and the success rate of unlocking.

FIG. 8 is a front perspective view of the connector according to the first embodiment. In addition, in order to enhance the correctness of connection between the plug connector 1 and the socket connector 2, again referring to FIG. 1 and FIG. 8, the first short side wall 253 is recessed with a first groove 256 from top to bottom, and the second short side wall 254 is recessed with a second groove 257 from top to bottom, and in some embodiments, the first groove 256 and the second groove 257 have the same recess depth (i.e., the length in the vertical direction), and the width of the first groove 256 may be smaller than the width of the second groove 257, but they are not limited to this configuration, and in another embodiment, according to the need of a product, the first groove 256 and the second groove 257 may have different recess depths, or the first groove 256 and the second groove 257 may have the same width. Further, when the vertical end 113 of the plug connector 1 extends into the slot 250 of the socket connector 2 and is electrically connected to the terminal group 23, the first longitudinal end 111 of the plug connector 1 can be accommodated in the first groove 256 of the socket connector 2 (as shown in FIG. 3 and FIG. 8), and the second longitudinal end 112 of the plug connector 1 can be accommodated in the second groove 257 of the socket connector 2 (as shown in FIG. 2A and FIG. 7), so the plug connector 1 can be accurately guided through the first groove 256 and the second groove 257 to the position for correct connection to the socket connector 2 and can be securely positioned in the socket connector 2.

Again referring to FIG. 1 and FIG. 8, the width of the first groove 256 is smaller than the width of the first short side wall 253 to form at least one first guide wall 2531, the width of the second groove 257 is smaller than the width of the second short side wall 254 to form at least one second guide wall 2541, such that when the plug connector 1 is connected to the socket connector 2, the first guide wall 2531 and the second guide wall 2541 may be respectively wrapped on the corresponding outer wall of the plug connector 1 (as shown in FIG. 2A and FIG. 3) to likewise perform a guiding function, while producing a straightforward effect to ensure that the plug connector 1 can only be connected to the socket connector 2 in the correct way. In this embodiment, a shell 25 having two first guide walls 2531, with the two first guide walls 2531 having the same width, is taken as an example, but the present application is not limited to this configuration, and according to product requirements, the two first guide walls 2531 may have different widths; similarly, the two second guide walls 2541 provided on the shell 25 may also have the same width or different widths.

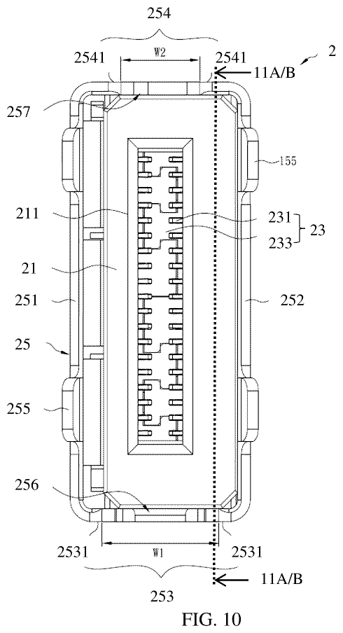

FIG. 9 is a rear perspective view of the socket connector according to the first embodiment. In an embodiment, referring to FIG. 7, FIG. 8 and FIG. 9, a socket connector 1 comprises an insulative housing 21, at least one terminal group 23, and a shell 25. For case of description, the top of FIG. 7 is a top of an assembly, the bottom of FIG. 7 is a bottom of the assembly, the lower left of FIG. 7 is the front of the assembly, the upper right of FIG. 7 is the rear of the assembly, the upper left of FIG. 7 is the left of the assembly, and the lower right of FIG. 7 is the right of the assembly. In addition, the insulative housing 21 is internally provided with a slot 210, and is provided with a mating interface 211 at one end (such as a top end), and the mating interface 211 can be in communication with the slot 210. However, in other embodiments of the present disclosure, according to actual product requirements, the insulative housing 21 can be provided with a plurality of insertion ports 211, and the insertion ports 211 can be in communication with the same slot 210; or the insulative housing 21 can be provided with a plurality of insertion ports 211 and a plurality of slots 210, and the insertion ports 211 can be respectively in communication with the slot 210.

Referring to FIG. 7, FIG. 8 and FIG. 9 again, the insulative housing 21 is provided with at least one positioning portion 115, and the shell 25 is provided with at least one positioning portion 158. The positioning portion 115 can be mated with the positioning portion 158 when the insulative housing 21 is assembled to the shell 25, so that the insulative housing 21 can be stably fixed into the shell 25. In this embodiment, the positioning portion 115 may be a bump, and an outer side of the bump adjacent to the top end is an inclined surface. The positioning portion 158 is an elastic sheet, and the elastic sheet is provided with a punched hole, which matches the bump, so that the bump can push the clastic sheet outward by the inclined surface and be embedded in the punched hole. However, according to actual product requirements, in some embodiments, the positioning portion 158 can only be a punched hole (that is, two sides of an area adjacent to the punched hole are provided with no gap) or in other forms. In addition, in order to prevent the insulative housing 21 from deviating from a predetermined position due to improper application of force during assembly to the shell 25, at least one bearing portion 115 protrudes on an outer edge of the insulative housing 21 adjacent to the other end (such as a bottom end). When the insulative housing 21 extends into the shell 25 from bottom to top, the bearing portion 115 can abut against an end edge of the other end (such as the bottom end) of the shell 25, so as to prevent the insulative housing 21 from excessively extending into the shell 25 and deviating from the predetermined assembly position. In addition, during use of the socket connector 2, when other connectors are being pulled out in the case that other connectors are inserted into the connector, the socket connector 2 bears an upward pulling force, and with the arrangement of the bearing portion 115, the insulative housing 21 can be effectively blocked by the shell 25, so that the insulative housing 21 is stably positioned at the current position.

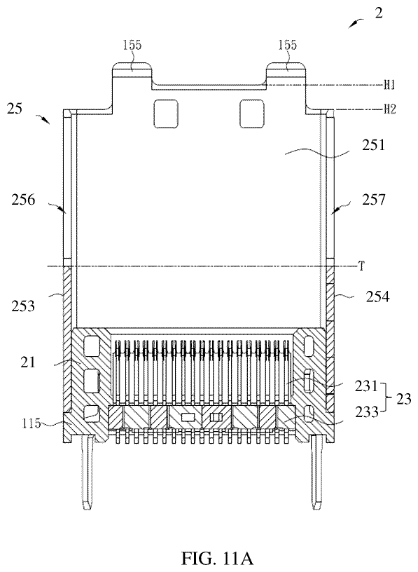

FIG. 10 is a top view of the socket connector according to the first embodiment. Furthermore, referring to FIG. 7, FIG. 8, FIG. 9 and FIG. 10, the shell 25 comprises a first long side wall 251, a second long side wall 252, a first short side wall 253, and a second short side wall 254. The first long side wall 251 may be used as a left side wall of the shell 25, with two sides (a front side and a rear side) respectively connected to the first short side wall 253 and the second short side wall 254; and the second long side wall 252 may be used as a right side wall of the shell 25, with two sides (a front side and a rear side) respectively connected to the first short side wall 253 and the second short side wall 254, so that the first short side wall 253 may be used as a front side wall of the shell 25, and the second short side wall 254 may be used as a rear side wall of the shell 25. The first long side wall 251, the second long side wall 252, the first short side wall 253 and the second short side wall 254 can be jointly enclosed to form a slot 250. In addition, a first groove 256 is recessed in the first short side wall 253 from top to bottom, and a second groove 257 is recessed in the second short side wall 254 from top to bottom. In some embodiments, recessed depths (lengths in a vertical direction) of the first groove 256 and the second groove 257 are the same, and a width W2 of the second groove 257 may be less than a width W1 of the first groove 256, but it is not limited thereto. In other embodiments, according to actual product requirements, the recessed depths of the first groove 256 and the second groove 257 may be different, or the width W1 of the first groove 256 and the width W2 of the second groove 257 may be the same.

Referring to FIG. 7, FIG. 8, FIG. 9 and FIG. 10 again, the width W1 of the first groove 256 is less than the width of the first short side wall 253 to form at least one first guide wall 2531, and the width W2 of the second groove 257 is less than the width of the second short side wall 254 to form at least one second guide wall 2541. Referring to FIG. 2A and FIG. 3 again, when a plug connector 1 is inserted into the socket connector 2, the first guide wall 2531 and the second guide wall 2541 can respectively cover corresponding outer walls of the plug connector 1, to achieve a guiding function as well as a foolproof effect, so as to ensure that the plug connector 1 can only be inserted into the socket connector 2 in a correct manner. In this embodiment, taking the shell 25 having two first guide walls 2531 as an example, the widths of the two first guide walls 2531 are the same, but it is not limited thereto. According to product requirements, the widths of the two first guide walls 2531 may be different from each other. Similarly, the widths of two second guide walls 2541 of the shell may be the same or different.

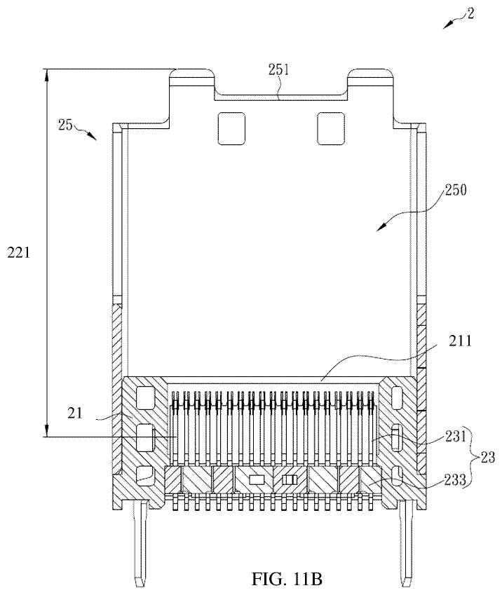

FIG. 11A is a first cross-sectional view of the socket connector according to the first embodiment. In addition, in order to improve the guiding effect, referring to FIG. 7 again, at least one tab 155 further protrudes at one end (e.g., the top end) of the shell 25, and each tab 155 is folded outward. In other words, each tab 155 is bent and folded in a direction away from the slot 250. Referring to FIG. 1 again, in this embodiment, when socket connector 2 is inserted into the socket connector 2, by the tab 155, the plug connector 1 can be conveniently moved into the slot 250 along the tab 155. In addition, in this embodiment, two tabs 155 are arranged at one end (top end) of the first long side wall 251, and the two tabs 155 are spaced apart by a certain distance, so that a horizontal height H1 of the first long side wall 251 between the two tabs 155 is greater than a horizontal height H2 of the first long side wall 251 not between the two tabs 155 (as shown in FIG. 11A). Similarly, in this embodiment, two tabs 155 may be arranged at one end (top end) of the second long side wall 252, and the two tabs 155 are spaced apart by a distance. A horizontal height of the second long side wall 252 between the two tabs 155 is greater than a horizontal height of the second long side wall 252 not between the two tabs 155. In this way, since the two above-mentioned tabs 155 and an area therebetween are at a higher position, they can be in contact with the plug connector 1 preferentially to achieve a better guiding effect. However, in other embodiments of the present disclosure, a horizontal height H1 of each of the first long side wall 251 and/or the second long side wall 252 between the two tabs 155 can be the same as a horizontal height H2 of each of the first long side wall 251 and/or the second long side wall 252 not between the two tabs 155.

Furthermore, in order to enable the socket connector 2 to be stably mated with the plug connector 1, referring to FIG. 1, FIG. 2A and FIG. 3 again, the second long side wall 252 of the shell 25 is provided with at least one second locking member 27. The second locking member 27 can be connected to a latching portion 143 of the plug connector 1, so that the socket connector 2 would not be easily separated from the plug connector 1, but it is not limited thereto. In other embodiments of the present disclosure, the second locking member 27 may be provided in the first long side wall 251, or the first long side wall 251 and the second long side wall 252 are both provided with second locking members 27, and the second locking members 27 may be adjacent to one end (e.g., the top end) of the shell 25. In this embodiment, referring to FIG. 1 and FIG. 11A again, heights of bottoms of the first groove 256 and the second groove 257 are the same (such as at a position of an imaginary line T), but it is not limited thereto. In some embodiments, the heights of the bottoms of the first groove 256 and the second groove 257 may be different. In addition, one end (top end) of the insulative housing 21 does not exceed the heights of the bottoms of the first groove 256 and the second groove 257. Therefore, when the plug connector 1 is inserted into the socket connector 2, an insertion area of the two connectors can be completely located in the shell 25 without being exposed, so as to obtain good protection and shielding effects. However, in other embodiments of the present disclosure, one end of the insulative housing 21 can be flush with or exceed the height of the bottom of each of the first groove 256 and/or the second groove 257 to meet requirements of different products.

FIG. 11B is a second cross-sectional view of the socket connector according to the first embodiment. In addition, again referring to FIG. 1, FIG. 7 and FIG. 11B, in the first embodiment, the socket connector 2 comprises an insulative housing 21, at least one terminal group 23, and a shell 25. The insulative housing 21 is internally provided with a slot 210 and is provided with a mating interface 211 at one end (for example, the top end) thereof, and the mating interface 211 can be connected to the slot 210. In yet another embodiment of the present application, according to need of a product, the insulative housing 21 may be provided with a plurality of mating interfaces 211, and the mating interfaces 211 can be connected to the same slot 210; alternatively, the insulative housing 21 may be provided with a plurality of mating interfaces 211 and a plurality of slots 210, and each mating interface 211 can be connected to each slot 210.

Further, again referring to FIG. 1, FIG. 7 and FIG. 11B, in the first embodiment, the terminal group 23 may be assembled into the insulative housing 21, which comprises at least a plurality of terminals 231, and, in this embodiment, the terminal 231 may also be fixed to a terminal housing 233 (but not limited thereto), each terminal 231 may be a power terminal, signal terminal, or grounding terminal according to its designated function, and the terminals 231 included in the same terminal group 23 may all be terminals with the same function, or terminals with different functions are arranged together. Further, after the terminal group 23 is assembled onto the insulative housing 21, one end of the terminal 231 may be exposed outside the slot 210 so that it can be electrically connected to the straight conductive blade 1251 of the plug connector 1.

Again, referring to FIG. 1, FIG. 7 and FIG. 11B, the shell 25 is provided with an open port at one end (for example, the top), which contains a slot 250, and the slot 250 can be connected to the open port. Further, the insulative housing 21 may be assembled into the slot 250, and the insulative housing 21 and the area of the shell 25 corresponding thereto can jointly form the vertical end 221. In addition, in some embodiments, the socket connector 2 does not comprise the shell 25, in which case one end of the insulative housing 21 can serve as the vertical end 221. Thus, the vertical end 113 of the plug connector 1 can pass through the open port, the slot 250, and the mating interface 211 from top down to extend into the slot 210 until the straight conductive blades 1251 are electrically connected to the corresponding terminals 231.

Further, again referring to FIG. 1 and FIG. 11B, in the first embodiment, the socket connector 2 is provided with two second locking members 27 adjacent to one end (for example, the top end) thereof, each second locking member 27 being a through hole, and the configuration of each through hole matches the configuration of the latching portion 143 of the first locking member 14, so that at least the tips of the latching portion 143 can extend into the corresponding through holes, respectively; however, the present application is not limited thereto, and, in another embodiment of the present application, the number and configuration of the second locking member 27 are changeable according to the first locking member 14. For example, the number of second locking member 27 is only one or three or more. Further, in this embodiment, when the vertical end 113 of the plug connector 1 extends into the slot 250 and is electrically connected to the socket connector 2 (for example, the terminal 231 and the straight conductive blade 1251 abut against each other), the tips of the latching portion 143 can respectively extend into the corresponding through holes, so that the first locking member 14 engages the second locking member 27 to form a locked state (as shown in FIG. 2A); then, when the user presses the activation portion 141 to separate the tips of the latching portion 143 from the corresponding through holes, the first locking member 14 and the second locking member 27 can form an unlocked state (as shown in FIG. 2B), so the user can easily unlock the plug connector 1 from the socket connector 2 simply by operating the first locking member 14, which greatly improves the convenience of use.

In addition, as shown in FIG. 1, the first locking member 14 and the second locking member 27 of the first embodiment are located on the same side (for example, the right side) of the connector assembly C and are unlocked by pressing, but the present application is not limited thereto; another form of first locking member and second locking member will be described below. Subsequent explanations will focus on the first locking member and second locking member, while other components that are identical or similar to the first embodiment will be briefly explained or omitted from the description.

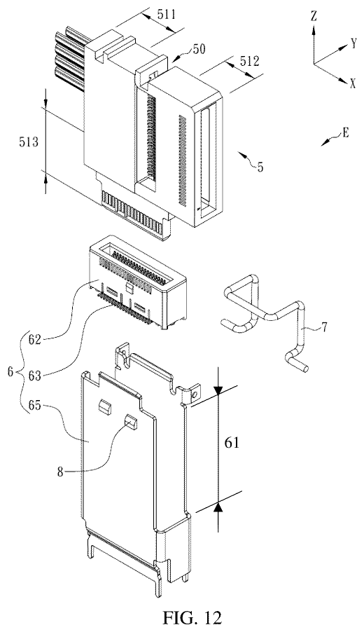

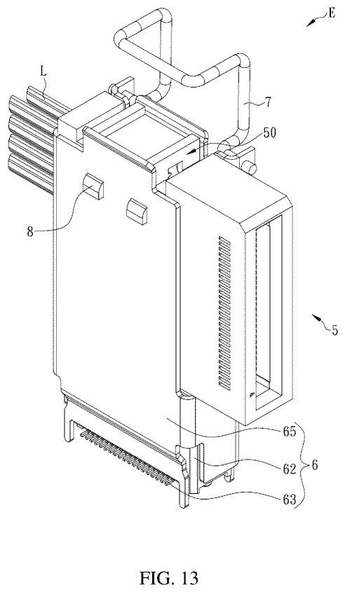

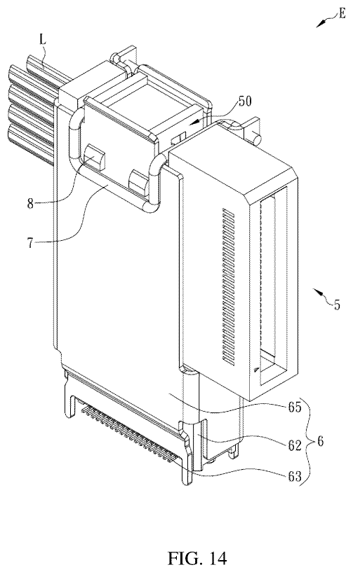

FIG. 12, FIG. 13 and FIG. 14 describe a connector assembly E according to a second embodiment. As illustrated, FIG. 12 is an exploded view of the connector assembly E, according to the second embodiment. FIG. 13 is a perspective view of the connector assembly E, illustrating an unlocked state between a first locking member and a second locking member, according to the second embodiment. FIG. 14 is a perspective view of the connector assembly, illustrating a locked state between a first locking member and a second locking member, according to the second embodiment. Referring to FIG. 12, FIG. 13 and FIG. 14, in a second embodiment, the connector assembly E comprises an plug connector 5, a socket connector 6, a first locking member 7, and a second locking member 8, and in order to unify component directions, the component direction in the second embodiment is determined according to the component direction in the first embodiment.

Again referring to FIG. 12, FIG. 13 and FIG. 14, the plug connector 5 is provided with a first longitudinal end 511 and a second longitudinal end 512, which are arranged extending along the longitudinal axis (X-axis) direction, the first longitudinal end 511 and the second longitudinal end 512 are opposite to each other, and, further, the first longitudinal end 511 may be located in a rear-end area of the plug connector 5 and can be electrically connected to at least one cable L; the second longitudinal end 512 may be located in a front-end area of the plug connector 5, which can be electrically connected to another connector, and the second longitudinal end 512 is connected to another connector substantially along the longitudinal axis (X-axis); the plug connector 5 is provided with a vertical end 513 along the vertical axis (Z-axis) direction, the vertical end 513 being located in the bottom-end area of the plug connector 5 and substantially extendible downward along the vertical axis (Z-axis) direction. Further, one end (for example, the top end) of the socket connector 6 is provided with a vertical end 61. The vertical end 61 can extend upward along the vertical axis (Z-axis) direction, and, when the socket connector 6 is connected to the plug connector 5, the vertical end 61 may be electrically connected from top down by the vertical end 513.

In the second embodiment, as shown in FIG. 12, FIG. 13 and FIG. 14, one end of the first locking member 7 is pivoted to the right sidewall of the socket connector 6, and when the first locking member 7 is flipped by a force, the other end thereof can go over the top of the socket connector 6 from the right of the socket connector 6 and move to the left of the socket connector 6. In addition, the second locking member 8 is arranged on the left sidewall of the socket connector 6, and, when the other end of the first locking member 7 is moved to the left of the socket connector 6, it can, corresponding to the position of the second locking member 8, form a locked state with the second locking member 8 (as shown in FIG. 14). The first locking member 7 and the second locking member 8 are arranged substantially along the transverse axis (Y-axis) direction, and a user can apply a force along the transverse axis (Y-axis) direction, causing the other end of the first locking member 7 to move from right to left to detach from the second locking member 8, which enables that the user's hand performs operations and motions also mainly in the direction of and around the transverse axis (Y-axis).

As shown in FIG. 12, FIG. 13 and FIG. 14, the socket connector 6 comprises an insulative housing 62, at least one terminal group 63, and a shell 65. The terminal group 63 is assembled into the insulative housing 62 and the insulative housing 62 is assembled into the shell 65; further, the first locking member 7 (for example, a frame) is pivoted to the shell 65, and the second locking member 8 (for example, a projection) may be independently or integrally fixed to the shell 65, facing the first locking member 7; thus, when the plug connector 5 is plugged into the socket connector 6, the user can flip the first locking member 7 by hand and cause the other end of the first locking member 7 to cross the plug connector and then lock onto the second locking member 8, so that the plug connector 5 is securely plugged into the socket connector 6; further, to unplug the plug connector 5, the user simply pulls the other end of the first locking member 7 by hand to separate the other end of the first locking member 7 from the second locking member 8, and then flips the first locking member 7 again, thereby pulling out the plug connector 5 smoothly. However, in another embodiment of the present application, according to the need of a product, the second locking member 8 may also be arranged on the plug connector 5 and clamped by the first locking member 7, rather than being limited to the position of the aforementioned socket connector 6.

Further, in order to reduce the height of the first locking member 7 in a locked state, in the second embodiment, as shown in FIG. 12, FIG. 13 and FIG. 14, the top side of the plug connector 5 may be recessed with at least one groove 50, and, when the first locking member 7 and the second locking member 8 are in a locked state, a partial part of the first locking member 7 may be accommodated in the groove 50, and in the direction shown in FIG. 13 and FIG. 14, the top area of the first locking member 7 is accommodated in the groove 50, without protruding from the top side of the plug connector 5, so that the overall height of the connector assembly E will not increase due to the first locking member 7.

Optionally, the sidewall of the housing is protrusively provided with two pivot blocks, which are spaced at a distance from each other, the first locking member is protrusively provided with a pivot portion on opposite sides, and each pivot portion is pivotable to the corresponding pivot blocks, so that the first locking member can rotate with each pivot portion as the center of axis of rotation.

Optionally, the plug connector further comprises an elastic element that is located between the housing and the first locking member and that can apply a force to the first locking member, the force causing the latching portion of the first locking member to move toward the sidewall of the housing.

Optionally, the housing is provided with an assembly slot for accommodating one end of the elastic element, and the other end of the elastic element can rest against the inner sidewall of the activation portion of the first locking member to push the activation portion away from the housing and move the latching portion toward the housing.

Optionally, the housing is provided with at least one grip portion protruding along the first axis direction corresponding to the position of the first longitudinal end and/or the second longitudinal end.

Optionally, the housing comprises a first subassembly and a second subassembly, wherein one end of the first subassembly is provided with a first mating portion, another end of the first subassembly is provided with a first longitudinal portion, the first longitudinal portion being opposite to the first mating portion, and yet another end of the first subassembly is provided with a vertical end; one end of the second subassembly is provided with the second longitudinal end, the other end of the second subassembly is provided with a second mating portion, and the second mating portion is opposite to the second longitudinal end, and the second mating portion can be further mated with the first mating portion.

Optionally, the first subassembly comprises a first insulative housing, a circuit board, and at least one cable, wherein one sidewall of the first insulative housing is pivotally provided with the first locking member, one end of the first insulative housing is provided with the first mating portion, another end of the first insulative housing is provided with the first longitudinal end, and yet another end of the first insulative housing is provided with the vertical end; the circuit board may be arranged in the first insulative housing, with one end exposed outside the vertical end, and one end of the circuit board is provided with a plurality of straight conductive blades; one side of the circuit board is provided with a plurality of first conductive blades, which may be exposed outside the first mating portion; each cable may extend into the first insulative housing through the first longitudinal end and may be electrically connected to the circuit board.

Optionally, the second subassembly comprises a second insulative housing and a plurality of terminals, wherein one end of the second insulative housing is provided with the second longitudinal end, the other end of the second insulative housing is provided with the second mating portion, and the second insulative housing is further provided with a mating interface corresponding to the position of the second longitudinal transition end, which is internally provided with a slot, wherein the slot can be connected to the mating interface; each terminal may be fixed to the second insulative housing, one end of which may be exposed outside the slot and the other end of which may be exposed outside the second mating portion, and, when the second subassembly and the first subassembly are mated, the other end of each terminal can be electrically connected to the corresponding first conductive blade.

Optionally, the shell comprises a first short side wall, a second short side wall, a first long side wall, and a second long side wall, wherein the first short side wall is provided with a first groove; the second short side wall is opposite to the first short side wall and is provided with a second groove; the two sides of the first long side wall are respectively connected to the first short side wall and the second short side wall; the second long side wall is opposite to the first long side wall, and the two sides thereof are respectively connected to the first short side wall and the second short side wall, so that the first short side wall, the second short side wall, the first long side wall, and the second long side wall surround the slot; when the socket connector is connected to the plug connector, the first groove of the shell can guide and accommodate the first longitudinal end of the plug connector, and the second groove of the shell can guide and accommodate the second longitudinal end of the plug connector.

Optionally, the width of the first groove is smaller than the width of the second groove.

Optionally, the width of the first groove is smaller than the width of the first short side wall to form at least one first guide wall, and the width of the second groove is smaller than the width of the second short side wall to form at least one second guide wall. Optionally, the second locking member is adjacent to one end of the shell.

Optionally, the second locking member is a through hole into which the latching portion of the first locking member of the plug connector may extend.

Optionally, the first locking member is pivoted to one sidewall of the plug connector, with one end provided with a activation portion and the other end provided with at least one latching portion, wherein, when the activation portion is displaced upon receiving a force, it causes each latching portion to move away from or toward said sidewall of the housing; the second locking member is arranged on one sidewall of the socket connector and can be interlocked with the latching portion to form a locked state; when the activation portion is pressed and displaced, the latching portion can detach from the corresponding second locking member to form an unlocked state.

Optionally, the sidewall of the plug connector is provided with two pivot blocks, which are spaced at a distance from each other, and the first locking member is provided with a pivot portion on two opposite sides, respectively, each pivot portion being pivotable to the corresponding pivot block so that the first locking member can rotate with each pivot portion as the center of axis of rotation.

Optionally, the connector assembly further comprises an elastic element that is located between the plug connector and the first locking member and is capable of applying a force to the first locking member, the force causing the latching portion of the first locking member to move toward the sidewall of the plug connector.

Optionally, one end of the first locking member is pivoted to one sidewall of the socket connector, and, when the first locking member is flipped by a force, the other end of the first locking member can cross one end of the socket connector to move to another sidewall of the socket connector, said another sidewall facing said one sidewall; the second locking member is arranged on another sidewall of the socket connector, and, when the plug connector is connected to the socket connector, the first locking member may be flipped by a force, so that the other end thereof can go over the plug connector to move to another sidewall of the socket connector and be interlocked with the second locking member to form a locked state; when the first locking member is again flipped by a force, the other end thereof can detach from the corresponding second locking member to form an unlocked state.

Optionally, the plug connector is provided with at least one groove at the end that faces away from the vertical end, and, when the first locking member and the second locking member are in a locked state, a local part of the first locking member can be accommodated in the corresponding groove.

Optionally, the plug connector further comprises a first subassembly and a second subassembly, wherein one end of the first subassembly is provided with a first mating portion, another end of the first subassembly is provided with a first longitudinal portion, the first longitudinal portion being opposite to the first mating portion, and yet another end of the first subassembly is provided with the vertical end; one end of the second subassembly is provided with the second longitudinal end, and the other end of the second subassembly is provided with a second mating portion, wherein the second mating portion is opposite to the second longitudinal end, and the second mating portion can be further mated with the first mating portion.

Optionally, the socket connector comprises an insulative housing, at least one terminal group, and a shell, wherein one end of the insulative housing is provided with at least one mating interface, the insulative housing is internally provided with at least one slot, and each slot can be connected to the corresponding mating interface; each terminal group may be arranged in the insulative housing, which comprises a plurality of terminals, and one end of the terminal may be exposed outside the slot; the shell is internally provided with a slot for accommodating the insulative housing.

Optionally, a width of the second groove is less than a width of the first groove.

Optionally, a height of a bottom of the first groove is different from a height of a bottom of the second groove.

Optionally, the height of the bottom of the first groove is equal to the height of the bottom of the second groove.

Optionally, at least one tab protrudes at one end of the shell, and each tab is bent and folded in a direction away from the slot.

Optionally, the first long side wall and/or the second long side wall are/is respectively provided with two tabs in a protruding manner, and a horizontal height of each of the first long side wall and/or the second long side wall between the two tabs is greater than a horizontal height of each of the first long side wall and/or the second long side wall not between the two tabs.

Optionally, a width of the first groove is less than a width of the first short side wall to form at least one first guide wall, and a width of the second groove is less than a width of the second short side wall to form at least one second guide wall.

Optionally, the first long side wall and/or the second long side wall are/is provided with at least one second locking member.

Optionally, each second locking member is adjacent to one end of the shell.

Optionally, the shell is provided with at least one positioning portion which is an elastic sheet, and the elastic sheet is provided with at least one punched hole.

Optionally, the shell is provided with at least one positioning portion which is a punched hole.

Optionally, one end of the insulative housing does not exceed heights of bottoms of the first groove and the second groove.

Optionally, the insulative housing is provided with at least one positioning portion, and the positioning portion can be mated with a positioning portion when the insulative housing is inserted into the shell.

Optionally, the positioning portion is a bump.

Optionally, at least one bearing portion protrudes on an outer edge of the insulative housing adjacent to the other end, and the bearing portion can bear an end edge abutting against the other end of the shell when the insulative housing is inserted into the shell.

While preferred embodiments of the present application have been particularly described above, the claims made in the present application are not limited thereto and all equivalent changes thereto that are readily conceivable to those of ordinary skill in the art on the basis of the technical content disclosed herein should fall within the scope of protection of the present application.

The present disclosure is not limited to the details of construction or the arrangements of components set forth in the foregoing description and/or the drawings. Various embodiments are provided solely for purposes of illustration, and the concepts described herein are capable of being practiced or carried out in other ways. Also, the phraseology and terminology used herein are for the purpose of description and should not be regarded as limiting. The use of “including.” “comprising.” “having.” “containing.” or “involving.” and variations thereof herein, is meant to encompass the items listed thereafter (or equivalents thereof) and/or as additional items.

What is claimed is:

1. An electrical connector comprising:
a housing comprising a first mating end extending in a first direction, and a second mating end extending toward a second direction perpendicular to the first direction; and
a locking member connected to a sidewall of the housing and configured to move between a locked position and an unlocked position by a force in a third direction perpendicular to both the first direction and the second direction.

2. The electrical connector of claim 1, comprising:
a circuit board held in the housing and comprising an end extending out of the second mating end of the housing, wherein:
the first mating end of the housing comprises a slot; and
the end of the circuit board comprising a plurality of contact pads.

3. The electrical connector of claim 2, wherein:
the housing comprises a third end opposite to the first end in the first direction;
the electrical connector further comprises a plurality of cables extending out of the housing from the third end; and
the plurality of cables are electrically connected to the circuit board.

4. The electrical connector of claim 1, wherein:
the locking member comprises an activation portion and a latching portion disposed opposite to the activation portion in the second direction;
the activation portion of the locking member is disposed above the housing; and
the latching portion is configured to move away from or towards the sidewall of the housing by the force in the third direction on the activation portion.

5. The electrical connector of claim 4, wherein:
the housing comprises a block protruding from the sidewall; and
the locking member is pivotably connected to the block.

6. The electrical connector of claim 4, further comprising:
an elastic element disposed between the housing and the locking member and configured to apply the force in the third direction to the locking member which moves the latching portion toward the sidewall of the housing.

7. The electrical connector of claim 6, wherein:
the elastic element comprises a first end accommodated in a slot of the housing, and a second end abutting an inner wall of the activation portion of the locking member.

8. The electrical connector of claim 3, wherein:
the housing comprises:
a first subassembly comprising the first mating end, and
a second subassembly connected to the first subassembly and comprising the second mating end and the third end;
the circuit board is held in the second subassembly; and
the locking member is connected to a sidewall of the second subassembly.

9. The electrical connector of claim 8, wherein the first subassembly comprises:
a first insulative housing comprises a slot at the first mating end; and
a plurality of terminals held in the first insulative housing, each of the plurality of terminals comprising a first end curving into the slot at the first mating end and a second end extending out of the first insulative housing and electrically connected to the circuit board held in the second subassembly.

10. A shell for an electrical connector, comprising:
a first long side wall;
a second long side wall opposing the first long side wall; and
front and rear short side wall opposing each other and joining the first and second long side walls, respectively, so as to form an enclosure with the first and second long side walls, wherein:
the front short side wall comprises a first groove recessed from a top; and
the rear short side wall comprises a second groove recessed from the top.

11. The shell of claim 10, wherein:
the second groove of the rear short side wall is narrower than the first groove of the front short side wall.

12. The shell of claim 11, wherein:
the first groove extends closer to a bottom than the second groove.

13. The shell of claim 12, wherein:
the first groove and the second groove have a same height in a top-to-bottom direction.

14. The shell of claim 11, comprising:
at least one tab protruding from the top, each of the at least one tab bent away from the enclosure.

15. The shell of claim 14, wherein:
the first long side wall comprises two tabs protruding from the top; and
the first long side wall is taller between the two tabs than outside the two tabs in a top-to-bottom direction and comprises at least a portion of a locking member.

16. The shell of claim 10, wherein:
the first groove is narrower than the first short side wall so as to form at least one first guide wall; and
the second groove is narrower than the second short side wall so as to form at least one second guide wall.

17. An electrical connector comprising:
a shell of claim 10;
an insulative housing disposed in the shell and below both the first groove of the front short side wall and the second groove of the rear short side wall, the insulative housing comprising a slot accessible from the top of the shell; and
at least one terminal group held in the insulative housing and comprising a plurality of terminals, each of the plurality of terminals comprising a first end curving into the slot of the insulative housing and a second end opposite the first end and extending out of the shell.

18. A connector assembly, comprising:
a plug connector comprising front and rear ends opposite to each other and both substantially extending along a first axis, and a vertical end extending substantially along a second axis perpendicular to the first axis;
a socket connector comprising a vertical end extending along the second axis and configured to with the vertical end of the plug connector;
a first locking member movably disposed on the plug connector or socket connector; and extending substantially along the second axis, wherein the first locking member may be operated to form a locked or unlocked state with the second locking member; and
a second locking member disposed on the socket connector or the plug connector and configured to mate with the first locking member so as to restrain movement between the plug connector and the socket connector along both the first axis and the second axis.

19. The connector assembly of claim 18, wherein the socket connector comprises:
a shell comprising:
a first long side wall;
a second long side wall opposing the first long side wall;
a front short side wall joining the first and second long side walls and a first groove recessed from a top and configured to receive the front end of the plug connector; and
a rear short side wall opposing the front short side wall and joining the first and second long side walls and comprising a second groove recessed from the top and configured to receive the rear end of the plug connector.

20. The connector assembly of claim 19, wherein:
the socket connector comprises an insulative housing disposed in the shell and below both the first groove and the second groove such that the shell holds a portion of the plug connector when the plug connector is mated with the socket connector;
the first groove is wider than the second groove; and
the shell of the socket connector comprises the second locking member disposed adjacent the top of the shell and configured to receive a latching portion of the first locking member disposed on the plug connector.
